(19) United States
(12) Patent Application Publication
(10) Pub. No.: US 2014/0286013 A1
(43) Pub. Date: Sep. 25, 2014

(54) ALUMINUM RADIATOR IN ONCE COMPRESSING FORMING AND DEMOLDING AND AN LED FOCUS LAMP

(71) Applicant: XIAMEN HI-LIGHT LIGHTING CO., LTD., Xiamen (CN)

(72) Inventor: Jinshui WU, Xiamen (CN)

(21) Appl. No.: 13/909,414

(22) Filed: Jun. 4, 2013

(30) Foreign Application Priority Data
Mar. 20, 2013 (CN) 201320129239.X

(51) Int. Cl. F21V 29/00; F21K 99/00

(52) U.S. Cl. CPC F21V 29/004; F21K 9/50
USPC 362/294; 165/148

(57) ABSTRACT

An aluminum radiator in once decompressing forming and demolding has a separator and a side wall made of aluminum alloy in once compressing forming, the side wall is constricted and extended from the periphery of the separator in the axial direction; the center of the outer surface of the separator is disposed with an assembly surface to fix an LED light resource; the periphery of the assembly surface is disposed with a light collecting surface to focus the light of the LED light resource; the periphery of the light collecting surface is disposed with a fixation part to fix the lamp shade. An LED lamp is disposed with both optical part and assembly part.

### FIELD OF THE INVENTION

The present invention relates to an aluminum radiator in once compressing forming and demolding and an LED focus lamp applied with the radiator thereof.

### BACKGROUND OF THE INVENTION

LED light resource has advantages in the photo chromic effect, service life, energy consumption and controllable performance, and it has gradually taken place of the traditional incandescent lamp, fluorescent lamp and other light resource and lamp. But LED lamp costs higher than the traditional light resource due to its material, manufacturing process and low yield of the product.

With the improvement of the LED chip and the encapsulation technology, the cost of the LED light resource has decreased. Being the highest cost in the LED lamp, the decreasing cost of the LED light resource optimizes the cost of the LED lamp. Considering that the LED light resource needs heat conducting and optical process, LED radiator is another high cost component in the LED lamp.

LED radiator is usually applied with high heat conductive material to couple to the LED light resource, and heat is transferred to the radiator and finally diffused to the air from the contact surface of the radiator and the air in heat convection way. So that the material of the radiator is one factor of the cost; at the same time, it needs to process the radiator with heat conductive material or heat convective material, the cost of process takes up a large part. On the premises of the material, how to improve the process of large radiator is an important research of the LED lamp. There is focus lamp, such as PAR or R traditional lamp, disposed with curved reflector with light collecting function. To replace the traditional lamp, the LED lamp needs to assemble the large radiator to the previous place of the reflector. Above all, the radiator is large in size, complex material processing and high process cost.

### SUMMARY OF THE INVENTION

To solve the problem that the existing LED radiator is high-cost, the present invention is provided with an LED focus lamp. The technical proposal is as below:

An aluminum radiator in once decompressing forming and demolding, wherein comprising a separator and a side wall made of aluminum alloy in once compressing forming, the side wall is constricted and extended from the periphery of the separator in the axial direction; the centre of the outer surface of the separator is disposed with an assembly surface to fix the LED light resource; the periphery of the assembly surface is disposed with a light collecting surface to focus the light of the LED light resource; the periphery of the light collecting surface is disposed with a fixation part to fix the lamp shade.

In another preferred embodiment, the assembly surface is a flat surface, a heat conductive adhesive is disposed between the assembly surface and the LED light resource.

In another preferred embodiment, the light collecting surface is conical surface, parabolic surface, multiple curved surfaces and the combination, the surface structure of the light collecting surface is polished and/or frosted.

In another preferred embodiment, the fixation part comprising an annular groove, the periphery of the lamp shade is disposed with a flange coupled to the annular groove.

In another preferred embodiment, the side wall is two-layer shaped, a convection space is disposed inside the side wall to receipt the heat convection air.

The technical proposal of an LED focus lamp applied with above radiator is as below:

An LED focus lamp, wherein comprising:

An aluminum alloy radiator, comprising a separator in once compressing forming and a side wall constricted and extended from the periphery of the separator in the axial direction; the centre of the outer surface of the separator is disposed with an assembly surface to fix the LED light resource; the periphery of the assembly surface is disposed with a light collecting surface to focus the light of the LED light resource; the periphery of the light collecting surface is disposed with a fixation part to fix the lamp shade; and

A main body, which is coaxial with the radiator, the inner of the main body is disposed with a drive inside to drive the LED light resource; one end of the main body is fixed to an assembly hole on the top of the side wall, the other end is fixed with a lamp holder.

the main body is disposed with a screw hole parallel to the axial direction, a screw is coupled to the screw hole and fixed to the screw hole fromis coupled and fixed to the screw from the outside of the separator in screw thread way.

In another preferred embodiment, the centre of the assembly surface is disposed with a hole for lead wire.

The advantageous effects of the technical proposal of the present invention are as below:

The present invention is provided with an LED lamp with fewer components and simpler assembly structure, and the radiator in once forming can use its surface area effectively to realize better heat transfer effect of the LED light resource. And the LED lamp is disposed with both optical part and assembly part, the cost of the forming process is low and the construction is simple.

### BRIEF DESCRIPTION OF THE DRAWINGS

The present invention will be further described with the drawings and the embodiments.

FIG. 1 illustrates the sectional view of the breakdown structure of the first embodiment of the present invention.

FIG. 2 illustrates the sectional view of the radiator 20 of the FIG. 1.

FIG. 3 illustrates the sectional view of the radiator 20 of the second embodiment of the present invention.

### DETAILED DESCRIPTION OF THE EMBODIMENTS

The first embodiment:

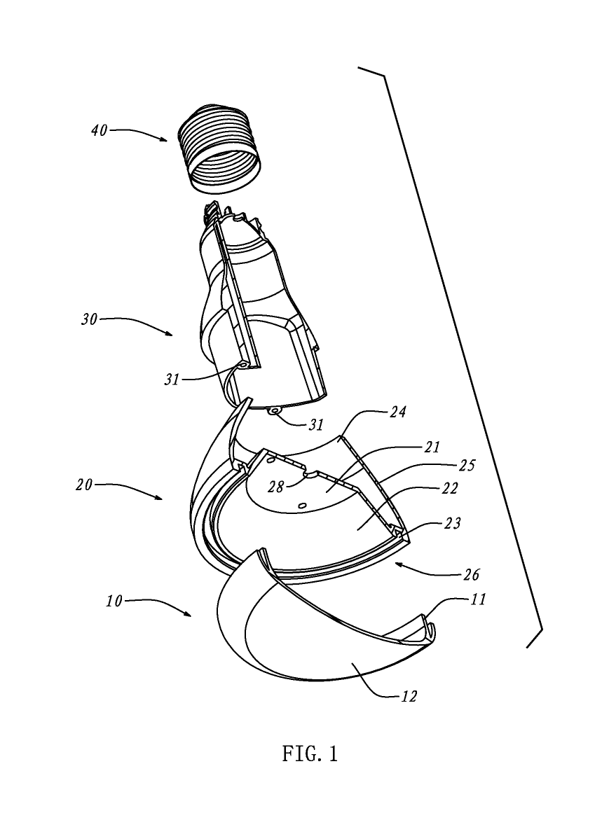

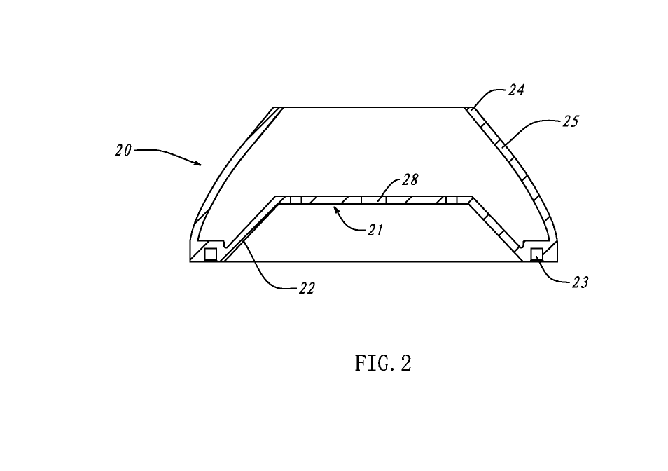

As figured in FIG. 1 and FIG. 2 of the first embodiment of the present invention. This embodiment is provided with a focus lamp. FIG. 1 is the breakdown structure of the main part, and FIG. 2 is the detail of the radiator 20.

In this embodiment, the main part comprising a radiator 20 in once forming, the radiator 20 is made of aluminum alloy in once compressing forming and demolding. The radiator 20 comprising a separator 26 and a side wall 25, the side wall 25 is constricted and extended from the periphery of the separator 26.

The centre of the outer surface of the separator 26 is disposed with an assembly surface 21, which is used to fix the LED light resource (not figure out). As the LED resource is usually panel shaped, heat conductive adhesive is coated on the assembly surface 21 to enhance the heat conductive effect with the LED light resource.

The periphery of the assembly surface 21 of the separator 26 is disposed with a light collecting surface 22, which is used to adjust and focus the light of the LED light resource. The light collecting surface 22 is conical surface, parabolic surface, multiple curved surfaces and the combination, the surface structure of the light collecting surface is polished and/or frosted. This embodiment is applied with conical surface. The periphery of the light collecting surface 22 is disposed with a fixation part 28, which is used to fix the lamp shade 10.

The main body 30 is coaxial with the radiator 20, the inner of the main body 30 is disposed with a drive to drive the LED light resource; one end of the main body 30 is fixed to an assembly hole 24 on the top of the side wall 25, the other end is fixed with a lamp holder 40.

This embodiment is provided with an LED lamp with fewer components and simpler assembly structure, and the radiator 20 in once forming can use its surface area effectively to realize better heat transfer effect of the LED light resource. And the LED lamp is disposed with both optical part and assembly part, the cost of the forming process is low and the construction is simple.

The technical proposal of this embodiment has other character as below:

The fixation part 23 of the radiator 20 comprising an annular groove, the periphery of the lamp shade 10 is disposed with a flange 11 coupled to the annular groove. The structure is convenient for the assembly of the lamp shade 10. Particularly, there is adhesive disposed between the groove and the flange 11 to fix above two.

The main body 30 is disposed with a screw hole 31 parallel to the axial direction, the screw hole 31 is coupled and fixed to the screw (not figure out) from the outside of the separator 26 in screw thread way. In this structure, fewer fixation structures need between the main body 30 and the radiator 20, and the assembly is faster. To assemble the LED light resource conveniently, the centre of the assembly surface 21 is disposed with a hole 28 for lead wire.

The second embodiment:

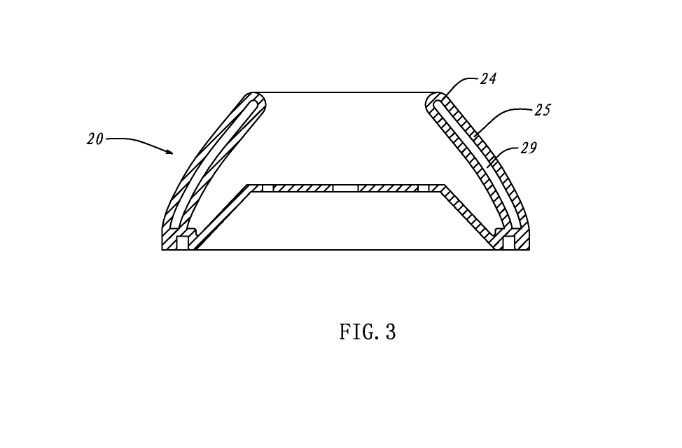

As figured in FIG. 3 of the second embodiment of the present invention. The components and the structure are similar to the first embodiment. The difference is that the side wall 25 of the radiator 20 is two-layer shaped, a convection space is disposed inside the side wall to receipt the heat convection air, making the radiator 20 in once forming with better heat conductive performance.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

What is claimed is:

1. An aluminum radiator in once decompressing forming and demolding, wherein comprising a separator and a side wall made of aluminum alloy in once compressing forming, the side wall is constricted and extended from the periphery of the separator in the axial direction; the centre of the outer surface of the separator is disposed with an assembly surface to fix the LED light resource; the periphery of the assembly surface is disposed with a light collecting surface to focus the light of the LED light resource; the periphery of the light collecting surface is disposed with a fixation part to fix the lamp shade.

2. An aluminum radiator in once decompressing forming and demolding according to claim 1, wherein the assembly surface is a flat surface, a heat conductive adhesive is disposed between the assembly surface and the LED light resource.

3. An aluminum radiator in once decompressing forming and demolding according to claim 1, wherein the light collecting surface is conical surface, parabolic surface, multiple curved surfaces and the combination, the surface structure of the light collecting surface is polished and/or frosted.

4. An aluminum radiator in once decompressing forming and demolding according to claim 1, wherein the fixation part comprising an annular groove, the periphery of the lamp shade is disposed with a flange coupled to the annular groove.

5. An aluminum radiator in once decompressing forming and demolding according to claim 1, wherein the side wall is two-layer shaped, a convection space is disposed inside the side wall to receipt the heat convection air.

6. An LED focus lamp, wherein comprising:
An aluminum alloy radiator, comprising a separator and a side wall in once compressing forming, the side wall is constricted and extended from the periphery of the separator in the axial direction; the centre of the outer surface of the separator is disposed with an assembly surface to fix the LED light resource; the periphery of the assembly surface is disposed with a light collecting surface to focus the light of the LED light resource; the periphery of the light collecting surface is disposed with a fixation part to fix the lamp shade; and
A main body, which is coaxial with the radiator, the main body is disposed with a drive inside to drive the LED light resource; one end of the main body is fixed to an assembly hole on the top of the side wall, the other end is fixed with a lamp holder.

7. An LED focus lamp according to claim 6, wherein the main body is disposed with a screw hole parallel to the axial direction, a screw is coupled to the screw hole and fixed to the screw hole from the outside of the separator in screw thread way.

8. An LED focus lamp according to claim 7, wherein the centre of the assembly surface is disposed with a hole for lead wire.

9. An aluminum radiator in once decompressing forming and demolding according to claim 2, wherein the side wall is two-layer shaped, a convection space is disposed inside the side wall to receipt the heat convection air.

10. An aluminum radiator in once decompressing forming and demolding according to claim 3, wherein the side wall is two-layer shaped, a convection space is disposed inside the side wall to receipt the heat convection air.

11. An aluminum radiator in once decompressing forming and demolding according claim 4, wherein the side wall is two-layer shaped, a convection space is disposed inside the side wall to receipt the heat convection air.
